(19) United States
(12) Patent Application Publication
(10) Pub. No.: US 2005/0053258 A1
(43) Pub. Date: Mar. 10, 2005

(54) System and method for watermarking a document

(76) Inventor: Joe Pasqua, Menlo Park, CA (US)

Correspondence Address: MORRISON & FOERSTER LLP, 1650 TYSONS BOULEVARD, SUITE 300, MCLEAN, VA, 22102, US

(21) Appl. No.: 09/987,608

(22) Filed: Nov. 15, 2001

Related U.S. Application Data
(60) Provisional application No. 60/248,192, filed on Nov. 15, 2000.

(51) Int. Cl. G06K 9/00

(52) U.S. Cl. 382/100

(57) ABSTRACT

This invention provides a system and method for inconspicuously and randomly encoding watermark information into a font encoding vector of document. The invention uses a random number generator to create a key that specifies which indices in the encoding vector should be modified to carry the watermark information. The key may also be used to detect and decode watermarks that were previously embedded into a font encoding vector.

### BENEFIT OF EARLIER FILED APPLICATION

This application claims the benefit of U.S. Provisional Application No. 60/248,192, filed Nov. 15, 2000, entitled “Document Watermarking Using Font Encoding Vectors.”

### FIELD OF THE INVENTION

This invention relates generally to systems and methods for digital watermarking and, more specifically, to systems and methods for embedding and detecting digital watermarks in documents.

### BACKGROUND OF THE INVENTION

Watermarking refers to a process of incorporating into a document identifying information that is ideally invisible, but at least not obvious, to the human eye. Thus, by placing a watermark in a document a copyright owner can be identified as the owner of the document even if the document has been processed, distorted, or copied. Watermarking is sometimes referred to as “fingerprinting.” Watermarks may be placed in images, video clips, audio clips, or documents.

Conventional watermarking schemes insert digital watermarks into an image or audio file by slightly modifying selected data samples of the file. Inserting watermark information into an image or audio file in this manner is generally acceptable because subtle changes of a data sample of an image or audio file are nearly imperceptible to a viewer or listener of the file.

Placing a digital watermark in a document is more challenging because there are fewer places to hide the watermark data. Many conventional techniques for watermarking documents make small changes in the visual appearance of the document and embed the watermark data in such changes. For example, a document may be changed by substituting words with synonyms, changing word and line spacing, and making small changes to character shapes. Other conventional techniques for adding a watermark to a document add watermark information to auxiliary data structures or unused space.

The conventional techniques for watermarking documents suffer several shortcomings. Making small changes in the visual appearance of the document, regardless of how small the changes are, changes the document. Therefore, a visual comparison of a original document to a document that has been watermarked by making small changes in the document reveals differences in the two documents. Such differences can indicate to an attacker that a watermark has been embedded in the document, which can lead to efforts by the attacker to erase or modify the watermark. Adding watermark information to auxiliary structures or unused space of a document does not change the visual appearance of the document and thus cannot be detected upon a visual comparison of an original document and a document watermarked in this manner. However, if a watermark is stored in an auxiliary structure or unused space of a document the watermark information can be removed from the document without impacting the document. If the watermark information is so removed, it cannot be used to identify an owner of the document and therefore does not add any value to the document.

Watermark embedding and detecting mechanisms must also be robust enough to prevent fraudulent manipulation and inaccurate detection.

To overcome the shortcomings of prior art methods for adding a watermark to documents, a robust digital watermarking technique to randomly and inconspicuously include identification information in a document is needed.

### SUMMARY OF THE INVENTION

This invention provides a robust watermark embedding and detecting system and method. Watermarks created with the invention do not create visible changes in a document and therefore provide no evidence that might lead an attacker to attempt an unauthorized manipulation.

In accordance with an embodiment of the invention a method for digitally watermarking a document is provided. The method includes rearranging an encoding vector to include watermark information and storing the rearranged encoding vector with the document.

In accordance with another embodiment of the invention a method to include identification information in a document is provided. The method includes scanning a document that is associated with the document to determine font encoding vectors, creating a key identifying a sequence of entries in the font encoding vector, and rearranging the encoding vector according to the key such that the identification information is included in the rearranged encoding vector.

In accordance with another embodiment of the invention a method to detect identification information included in a document is provided. The method includes scanning a document associated with the document, determining whether an encoding vector included in the document is a standard encoding vector, determining whether a pair of indices of the encoding vector has been modified, and determining a watermark value according to the pair of indices of the encoding vector that has been modified.

In accordance with yet another embodiment of the invention a system to include identification information in a document is provided. The system includes a client including a document and a module that scans a document associated with the document, determines font encoding vectors included in the document, creates a key identifying a sequence of entries in the font encoding vector, and rearranges the encoding vector according to the key.

In accordance with still another embodiment of the invention a system to extract identification information from a document is provided. The system includes aclient including a document and a module that scans a document associated with the document, determines whether an encoding vector included in the document is a standard encoding vector, determines whether a pair of indices of the encoding vector has been modified, and determines a watermark value according to the pair of indices of the encoding vector that has been modified.

In accordance with another embodiment of the invention a system to digitally watermark a document is provided. The system includes a client including a document and a module that rearranges an encoding vector to include watermark information and stores the rearranged encoding vector with the document.

### BRIEF DESCRIPTION OF THE DRAWINGS

FIG. 1 depicts an exemplary illustration of the components of the invention.

FIG. 2 depicts an exemplary font encoding vector.

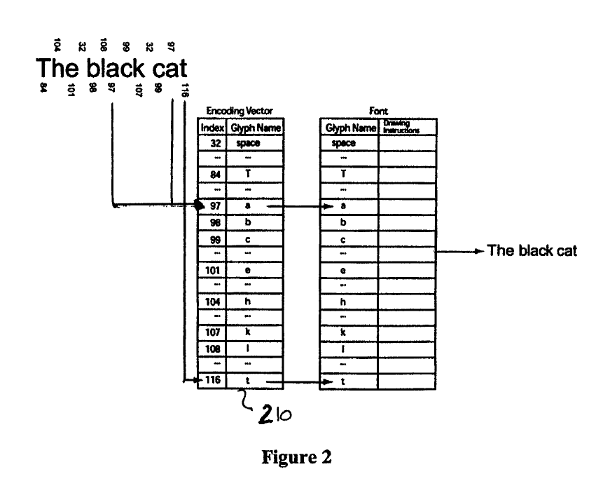

FIG. 3 depicts the encoding vector of FIG. 2 that has been of modified to an encoding vector.

FIG. 4 depicts an exemplary processing performed to embed a watermark in an encoding vector.

FIG. 5 depicts the modified encoding vector of FIG. 3 with glyph indices updated to match.

FIG. 6 depicts an exemplary processing performed to detect a watermark that has been embedded in an encoding vector.

### DETAILED DESCRIPTION OF THE INVENTION

This invention provides a robust digital watermarking system and method that embeds and detects watermarks, which are invisible, in an integral part of a document. The invention can be used to embed or detect a watermark in any document that is described in a page description language according to a rich document format. A rich document format refers to a document whose description includes encoding vectors to describe fonts included in the document. Adobe® PDF® and Adobe® PostScript® are examples of document formats that incorporate encoding vectors.

In particular, in the invention identification information is embedded into a document in a manner that does not produce any visual change to the document so that a visual comparison of a watermarked document with the original will not reveal any differences. Furthermore, the invention does not add identification information to auxiliary data structures or unused space of a document, i.e., the watermark data is not included as a non-essential part of the document that could be altered or destroyed without effecting the document. Rather, the watermarks created according to the invention are integrally related to the document in which they are embedded. This invention deals with watermarks in an electronic, or digital, form. Thus, the watermarks are versatile, easily distributed, and can be copied perfectly.

More specifically, the invention embeds a watermark in a font encoding vector included in, for example, a portable document format (PDF) file associated with a document. Further details of font encoding vectors are provided below. A key indicates which indices of, i.e., entries in, the encoding vector should carry the watermark information. Keys may be generic to a particular font included in a document, or may be specific to a particular instance of a font. A generic key would encode each encoding vector of a document according to the same key, whereas a specific key would only be used to encode a particular instance of an encoding vector and all subsequent encoding vectors would be encoded according to different keys.

The invention therefore relies on the fact that there are semantically equivalent ways to express the same visual representation of a document. Thus, by varying the specifics of how a document expresses its representation, additional information can be encoded in the representation of the document. For example, if there are two semantically equivalent ways to display a bit of text and an original document uses a first method, then a zero bit can be encoded by continuing to use the first method and a 1 bit can be encoded according to a different method. Thus, no change to the visual appearance of the document occurs since ultimately all of the same characters are drawn. In effect, the invention changes they way character shapes are accessed.

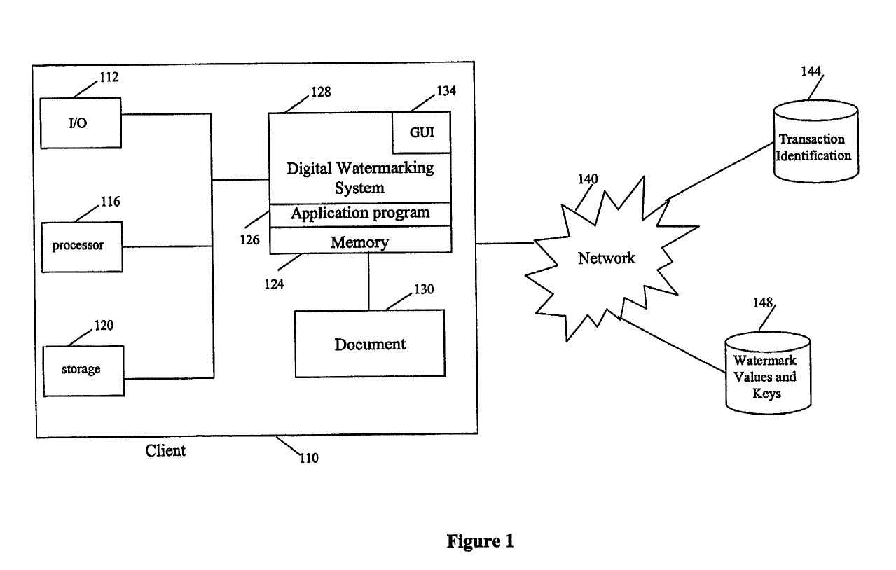

FIG. 1 depicts an exemplary illustration of a digital watermarking system that is consistent with the invention. Client 110 includes a conventional input/output device 112, processor 116, storage 120, and memory 124. Memory 124 further includes application program 126, which corresponds to a conventional document processing program, and digital watermarking system 128. Application program 126 represents a specific application that is used to create document 130. Among other things, application program 126 includes a set of font definitions that correspond to entries in a font encoding vector, described further below. Digital watermarking system 128 embeds watermarks into one or more encoding vectors of document 130 and detects watermarks that have been embedded in document 130.

Digital watermarking system 128 is not included as part of application program 126. Rather, it is separate application or server process that manipulates a document that was created by application program 126. Digital watermarking system 128 may operate automatically, in a batch mode, or may operate in response to a user's inputs. Therefore, digital watermarking system 128 includes a graphical user interface 134 that allows a user to access the system. For example, via graphical user interface 134, a user may specify a number of font encoding vectors of a particular document which should carry watermark information, which is referred to as the “strength” of the watermarking to be applied to a document.

One of skill in the art will appreciate that this invention may be used with a document in any document description language that includes encoding vectors. Examples of such documents include documents in Adobe® PDF® or Adobe® PostScript® formats.

Client 110 may be connected to a network 140, which is connected to various servers and/or repositories of information. Transaction identification information 144 is generated and stored each time digital watermarking system 128 is used to mark a document. This information may be retrieved as needed to determine details of a particular processing. The transaction information may include, for example, the name and address of the person receiving the document, the name or other identification information of the document being watermarked, the date on which the transaction occurred, and the price, if applicable, of the document. A repository 148 stores watermark values and keys and matches various watermark values with their corresponding keys. Information in this repository may be used, for example, to detect and decode existing watermarks.

One of skill in the art will appreciate that digital watermarking system 128 may include additional or different components and that this description is merely exemplary. For example, repositories 144 and 148 may be included in a server or host machine, or in client 110.

As described above, the invention embeds and detects watermark values in encoding vectors of a document and therefore may be used in any document format that includes encoding vectors. Adobe® PDF®, for example, is a universal file format that preserves the fonts, formatting, colors, and graphics of a source document, regardless of the application or platform used to create it. A PDF file provides a device-independent file format that describes a document in a manner that is independent of the original application software, hardware, or operating system that was used to create the document. A PDF file includes objects that describe separately the text and graphics of a document. In a PDF file, the text of a document is represented as a series of glyphs. A PDF file can be used to describe documents including any combination of text, graphics, and images.

A “glyph” is a graphical representation of a symbol that corresponds to a character, a part of a character, or a sequence of characters. More specifically, a glyph is a shape that corresponds to a character, a part of a character, or a sequence of characters. A font is defined by the set of glyphs included in it. A font is therefore a collection of glyphs of some style. A “font encoding vector” is a vector that includes the names of glyphs included in a set of glyphs that define a font. A font encoding vector provides a mapping between a glyph index and a glyph name. A font maps between a glyph name and drawing instructions for the glyph. For example, if element 32 of a font encoding vector is the glyph name “space,” then the number 32 maps to the space character. A font encoding vector includes 256 elements, although all of the elements may not be used, i.e. have values assigned to them. Typically, at least 150 elements of an encoding vector are used. Throughout this document, the terms font encoding vector and encoding vector are used interchangeably. A watermark is embedded in an encoding vector using the presence or absence of encoding changes of specific elements of the vector. A typical Roman font uses glyphs for letters, numbers, and well-known symbols. For example, a single glyph can represent a sequence of characters, such as, “ffi.” On the other hand, a glyph may correspond to a part of a character, e.g., an accent mark. In this case, multiple glyphs are used to represent a single character.

A PDF file includes sequences of glyph indices that describe what glyphs should be included on a page. Since glyph indices are often in the range of ASCII characters, these sequences of glyph indices often look like strings of text. In particular, a PDF specification defines a number of “well known” font encodings, i.e., encodings. It defines the names of these encodings and how each encoding maps glyph indices to glyph names. If a font in a PDF file uses a standard encoding, then the details of the font's encoding scheme, i.e., details indicating how the encoding maps glyph indices to glyph names, does not need to be included in the PDF file. On the other hand, fonts that do not use a standard encoding need to include in the PDF file details indicating how the font encoding maps glyph indices to glyph names. There is no specific location for a font encoding description in a PDF file, so long as the encoding can be accessible from the font object.

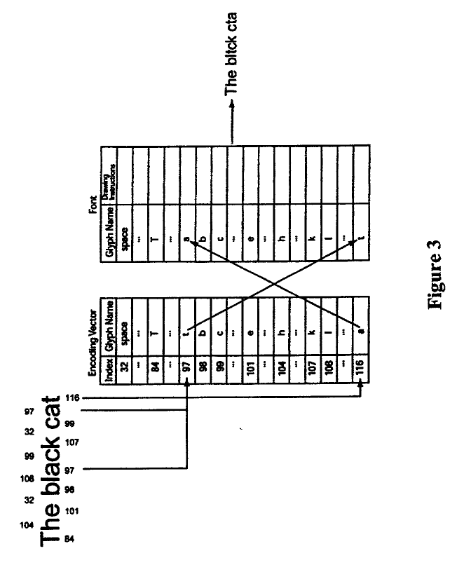

In a PDF file, a glyph of a font is referenced according to an index of a font encoding vector. The PDF file refers to characters with glyph indices rather than glyph names to conserve space. And the encoding vectors provide the mapping from glyph indices to glyph names, as described above. Thus, from a PDF file, each glyph index is looked up in the encoding vector to find the name of the glyph that corresponds to the glyph index. The glyph name is then looked up in the font to find drawing instructions indicating a sequence of shapes to be drawn to create the glyph. The glyph can then be rendered according to the instructions. FIG. 3 depicts an exemplary standard font encoding vector. In FIG. 3, the encoding vector and font are displayed separately. The source document of FIG. 3 corresponds to “The black cat.” Each of the characters included in the source document serves as an index of encoding vector 310. As described above, the encoding vector maps each index to a glyph name. And each glyph name is mapped to drawing instructions according to a particular font. According to the encoding of FIG. 3, the output characters correspond to “The black cat.”

A font encoding vector may alternatively conform to a nonstandard format. For example, a program that produces a PDF file could use character code 97 for “T” and character code 84 for “a.” If so, each time a “T” is produced glyph index 97 is referenced and each time an “a” is produced glyph index 84 is referenced. In this nonstandard encoding scheme, when reviewing the PDF file according to a standard encoding format, the “T”'s look like “A”'s and vice versa. Therefore, it is necessary to determine the specifics of a font encoding vector that has been used to create a particular document . By examining a font, the encoding of the font can be determined. A nonstandard encoding is generally listed as a standard encoding having enumerated differences. For example, a given font might use the standard encoding named “WinAnsiEncoding,” or it might use that encoding with a specific list of differences indicating how the custom encoding differs from the standard, original encoding.

A “key” refers to a number that is used to determine where in an encoding vector a watermark is to be (or has been) embedded. By using a different key for different documents, the same watermark can be embedded in different locations for each of the different documents without becoming vulnerable to an attacker because the attacker cannot access a generic document location to read, remove, or manipulate watermark information. In particular, in this invention, the key is used to determine which indices of an encoding vector correspond to which bits in a watermark. In one document, the first bit of a watermark might correspond to the index pair (53, 112) while in another document, using a different key, the first bit of a watermark might correspond to the index pair (34, 77). Without the key that was used to embed a watermark, the watermark cannot be detected and correctly reconstructed. Thus, the keys that are used to embed a watermark are also used to detect the watermark. Keys can be created by a human being or by a program, such as, for example, an automated key generation process. Once a key is created it is explicitly linked to a document. The creation of keys is beyond the scope of this invention and is well-known to those of ordinary skill in the art.

However, two examples are provided for clarity. In the first example a user is asked to enter a passphrase. This passphrase is a string of at least eight numbers, letters, and punctuation symbols. This string is then hashed using the MD5 message-digest algorithm to obtain a 128-bit number. This 128-bit number is divided into four 32-bit numbers. The numbers are then added together modulo 4,294,967,296 (2 to the 32nd power) to result in a single 32-bit number that is the key. In the second example a 32-bit key is created with a call to any one of many readily available pseudo-random number generators that return a 32-bit number. The pseudo-random number generator may use well known software techniques or it may rely on sophisticated hardware-based techniques. Any of these key creation techniques will result in a 32 bit hexadecimal number such as 0xAF356C7B. Since this key will be used as input to a second pseudo-random number generator, a 32-bit length is adequate.

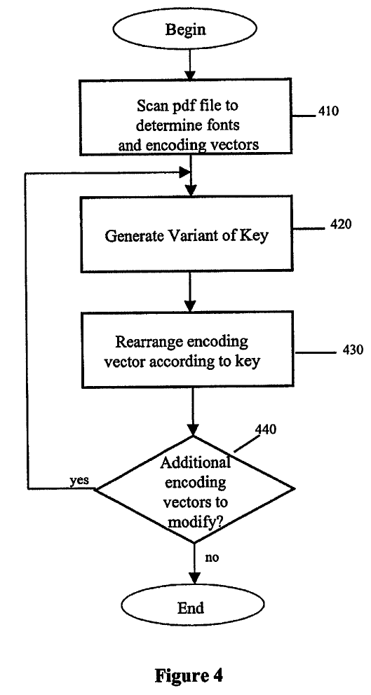

FIG. 4 depicts an exemplary processing performed to embed a watermark in an encoding vector of a document. The system receives the following data and uses it to embed a watermark into an encoding vector: an original document, a key, a watermark to be embedded, and an indication of the strength with which the watermark should be embedded. First, a document corresponding to the document is scanned to locate a sufficient number of encoding vectors to carry the watermark with the requested strength (410). Once the PDF file has been scanned and the font encoding vectors have been determined, the invention processes each encoding vector in turn (420). As indicated above, a user indicates a strength of the watermarking, which the system translates into a number of encoding vectors to modify. The system generally modifies multiple encoding vectors to encode the same watermark value. Using a single key to modify multiple encoding vectors to encode the same watermark value leaves the system more vulnerable to attacks. Therefore, the invention can use multiple keys to modify multiple encoding vectors of a single document to carry a single watermark value. Since the key controls how an encoding vector is modified, a different key is generated to modify each encoding vector. The generated key is referred to herein as a “variant” of the key. A variant key can be generated in a variety of ways, including, for example, combining the original key with a nonchanging aspect of the font, e.g., character width or font name, whose encoding vector is being modified.

For each encoding vector, the invention generates a variant of the input key based on information about the font with which the current encoding vector is associated, e.g., font name. This variant key is used as the seed to a pseudo random number generator which returns a deterministic sequence of pseudo-random numbers. The sequence of random numbers indicates the pairs of indices of the encoding vector that will carry watermark information. The random numbers are scaled, as appropriate, to correspond to specific indices of an encoding vector. One of ordinary skill in the art will appreciate that using a pseudo random number generator to generate a pseudo-random sequence of numbers is well known and therefore not described in further detail here.

The pair of indices of the encoding vector that will carry the watermark information are modified according to the key. Thus, to encode a 64 bit watermark 64 pairs of indices of the encoding vector are chosen. These locations are determined according to the key.

Next, the encoding vector is rearranged according to the key (430). The system repeats the processing of 420 and 430 for each of the font encoding vectors that need to be modified (440).

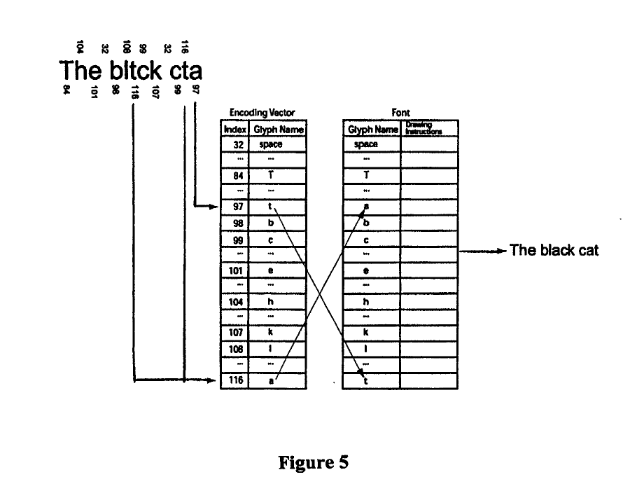

Each bit of a watermark corresponds to a pair of encoding vector indices. Thus, for each ‘0’ bit of a watermark, the indices of the font encoding vector that correspond to the bit remain the same, i.e., they are not changed; for each ‘1’ bit of a watermark, the corresponding pair of indices are swapped. FIG. 5 depicts the encoding of vector 310 of FIG. 3 that has been modified to carry watermark information. That is, the glyph indices of this vector have been updated to match the modified encoding vector. As depicted in FIG. 5, the index to name mapping for indices 97 and 116, which correspond to glyphs ‘a’ and ‘t,’ have been swapped. Thus, if the same input glyph indices are used to create the input characters, the resulting output is “The bltck cta.” After updating an encoding vector, as depicted in FIG. 5, the corresponding glyph indices in the source document are updated in a corresponding manner. In this example, all references to glyph indices 97 and 116 are swapped so that the encoding vector will yield the appropriate resulting text. Thus, while the input text appears to be “The bltck cta,” the output is rendered consistent with that of the source document as “The black cat.”

As described above, a user can specify a number of encoding vectors to modify, indicating the strength of the watermarking. The strength of the watermarking may be specified by the user according to a scale including, for example, ranges between low to high. The invention interprets the strength indication and determines how many encoding vectors need to include embedded watermark information to achieve such strength. Thus, for example, if a user indicates a maximum strength, every encoding vector in the document may be marked. And if the user indicates only a minimum strength, merely one or two vectors may be marked. A single key may be used to encode the watermark in multiple encoding vectors of a particular document or a different key may be used to encode the watermark in multiple encoding vectors of a particular document. Either way, embedding multiple redundant copies of a watermark reduces the likelihood that an embedded watermark will fail to be detected and increases the difficulty of forging a watermark. Varying the keys used to encode the watermark in each encoding vector makes forging a watermark even more difficult. A key that is specific to a particular font may also be used. For example, a key may be combined with data that is unique to a particular font being encoded, e.g., a width of characters included in the font. Ideally, a different key will be used for each font in a document and each key can be derived from the original key and some constant, i.e., unchanging characteristic of the font, such as its name or character widths. For example, the character widths of a font could be hashed into a 32 bit number which is XOR'd with the original key to create a key that is specific to that font. A similar operation could be performed using the name of the font. The invention accounts for perturbations of the data by an attacker by supporting multiple redundant copies of a particular watermark in a document. The invention can include additional error correcting codes.

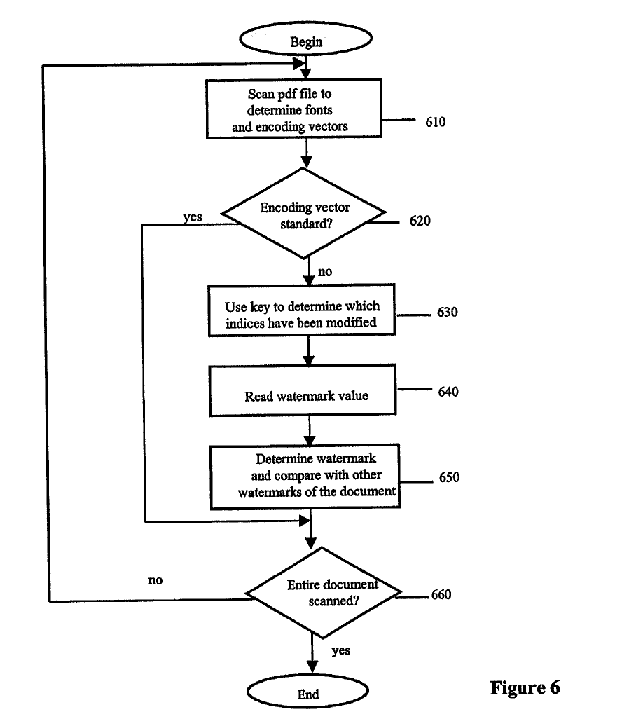

FIG. 6 depicts an exemplary processing performed to detect a watermark in an encoding vector of a document. A watermarked document and a key are provided to the system so that it can detect a watermark that has been encoded in an encoding vector of a document.

First, the watermarked document is scanned to locate the encoding vectors of the document (610). For each encoding vector, the system determines whether it is a standard encoding vector by comparing the encoding vector to a set of standard vectors, which are defined in the PDF specification (620). Relative to this processing, the system determines whether the encoding vector matches a description of a pre-defined encoding vector. The system compares the encoding vector, entry by entry, to those defined in the PDF specification. If there is an entry-by-entry match, then the encoding is an unchanged standard encoding. If the encoding vector does not match a predefined encoding vector, the system uses the key, or a variant thereof, to determine which indices of the vector have been modified (630). The system uses the same key to detect the watermark that it used to embed the watermark. Thus, if during embedding the system used the same key for every encoding vector, then the detection process uses the key that has been provided. If, however, during embedding, the system used a variant of the key for each different encoding vector then the same algorithm is used to derive the variant.

The key that corresponds to the watermark, i.e., the key that was used to embed the watermark, is used to generate a list of indices reflecting the watermark (the same list of 64 pairs of indices). Each pair of indices of an encoding vector is examined to determine whether the pair has been swapped. If the pair of indices has been swapped, then the watermark value corresponds to a 1 bit; if the pair of indices has not been swapped, then the watermark value corresponds to a 0 bit. The system the reads the watermark values for each encoding vector in this manner and stores the read values until all of the encoded encoding vectors of a document have been processed (640).

Once each of the encoding vectors that was encoded relative to FIG. 5, above, has been processed, the watermark values are compared to one another to determine whether the value was read accurately and whether any tampering has occurred (650).

By comparing detected watermark values with other watermarks included in the document, specific information about the watermark can be determined. For example, if a watermark has been embedded multiple times and the detected watermark values are not all the same, that indicates that someone may have tampered with the watermark and perhaps with the document. Thus, this process is repeated until the entire document is scanned (660).

This system and method for encoding and detecting watermarks in documents is especially robust in guarding against watermark manipulation and inaccurate detection in several ways. A “false positive” refers to detecting a watermark that was not actually applied. For example, a false positive could occur if a document generating program itself created a legitimate custom re-encoding of a font which originally had a well-known encoding. The keys minimize the likelihood of false positives since a re-encoding requires index changes that match those generated by the key. A “false negative” refers to failing to detect a watermark that was applied. A false negative may occur when a document is reprocessed such that a font is re-encoded. Since the invention does not make any visible changes to the document, i.e., no visible changes that are viewable by a human or a visual comparison program, potential attackers are unaware that a watermark exists and therefore have little motivation to re-encode an encoding vector. A “forged value” refers to detecting a watermark that is different from what was applied. For example, an attacker could try to modify the value of a watermark. To do this, the attacker would have to determine how the encoding vectors have been changed and modify them and the text accordingly to encode a new value. To increase the difficulty of such an attack, the invention embeds the watermark in a document multiple times and may vary how the watermark is encoded. When detecting a watermark, the invention reads multiple redundant watermarks and compares the values for consistency. Thus, if an attacker fails to make consistent changes to many encoding vectors, a forgery attempt will be unsuccessful.

Although the invention has been described relative to a particular embodiment, one of skill in the art will appreciate that this description is merely exemplary and the system and method of this invention may include additional or different components, while operating within the scope of the invention. For example, while the invention is described relative to embedding and detecting watermark values in documents represented as PDF files, the invention may be used with any document description format that includes encoding vectors. Similarly, the use of pair-wise swapping of entries in the encoding vector is only one mechanism for permuting that vector. Any number of mechanisms can be used to permute the entries in an array. Thus, the invention includes other permutation schemes as well as those disclosed herein. The scope of the invention is therefore limited only by the appended claims.

1. A method for digitally watermarking a document, comprising:
rearranging an encoding vector to include watermark information; and
storing the rearranged encoding vector with the document.

2. The method of claim 1, wherein the rearranging includes rearranging pairs of indices of the encoding vector according to a key.

3. A method to include identification information in a document, comprising:
scanning a document that is associated with the document to determine font encoding vectors;
generating a key identifying a sequence of entries in the font encoding vector; and
rearranging the encoding vector according to the key such that the identification information is included in the rearranged encoding vector.

4. The method of claim 3, wherein the document is a portable document format file.

5. The method of claim 3, wherein a user specifies a number of font encoding vectors to rearrange according to the key.

6. The method of claim 3, wherein the rearranging includes embedding identification information into the document by swapping pairs of indices of the encoding vector.

7. A method for detecting a watermark in a digitally watermarked document, comprising:
determining whether an encoding vector of the document has been modified according to a key; and
reading the watermark from the encoding vector according to the key.

8. The method of claim 7, wherein reading the watermarking includes reading the watermark from the encoding vector according to a variant of the key.

9. A method to detect identification information included in a document, comprising:
scanning a document associated with the document;
determining whether an encoding vector included in the document is a standard encoding vector;
determining whether an index of the encoding vector has been modified; and
determining a watermark value according to the index of the encoding vector that has been modified.

10. The method of claim 9, further comprising comparing the watermark value to another watermark value of a watermark extracted from the document.

11. A system to include identification information in a document, comprising:
a client including a document and a module that scans a document associated with the document, determines font encoding vectors included in the document, creates a key identifying a sequence of entries in the font encoding vector, and rearranges the encoding vector according to the key.

12. The system of claim 11, further including a repository that matches the identification information to the key.

13. A system to extract identification information from a document, comprising:
a client including a document and a module that scans a document associated with the document, determines whether an encoding vector included in the document is a standard encoding vector, determines whether an index of the encoding vector has been modified, and determines a watermark value according to the indices of the encoding vector that has been modified.

14. A system to digitally watermark a document, comprising:
a client including a document and a module that rearranges an encoding vector to include watermark information and stores the rearranged encoding vector with the document.

15. A method to embed a watermark in a document, comprising:
scanning a document to locate one or more encoding vectors that can include the watermark;
generating a variant key of an input key according to information about a font that is associated with a specific encoding vector;
generating a sequence of pairs of indices into the encoding vector that correspond to the key; and
embedding the watermark in the encoding vector according to the pairs of indices.

16. The method of claim 15, further including receiving information that corresponds to an indication of a number of the one or more encoding vectors that include the watermark.

17. A method to detect a watermark that is included in a document, comprising:
scanning the document to locate one or more encoding vectors that can include the watermark;
generating a variant key of an input key according to information about a font that is associated with a specific encoding vector;
generating a sequence of pairs of indices into the encoding vector that correspond to the key; and
reading the watermark in the encoding vector according to the pairs of indices.

18. The method of claim 17, further including receiving information that corresponds to an indication of a number of the one or more encoding vectors that include the watermark.

19. A system to include identification information in a document, comprising:
a client including the document and a module that scans the document associated with the document, rearranges an encoding vector of the document to include watermark information, and stories the rearranged encoding vector with the document.

20. A system to detect identification information from a document, comprising:
a client including the document and a module that determines whether an encoding vector of the document has been modified according to a key, and reads the watermark from the encoding vector according to the key.
